(19) United States
(12) Patent Application Publication
(10) Pub. No.: US 2024/0167234 A1
(43) Pub. Date: May 23, 2024

(54) Spreader Assembly

(71) Applicant: Stabilcorp Pty Ltd, Wauchope (AU)

(72) Inventor: Craig Steven Pinson, Bonny Hills (AU)

(21) Appl. No.: 18/512,218

(22) Filed: Nov. 17, 2023

(30) Foreign Application Priority Data
Nov. 18, 2022 (AU) 2022903487

(51) Int. Cl. E01C 19/20

(52) U.S. Cl. CPC E01C 19/2025

(57) ABSTRACT

A mobile assembly for delivering materials to a road surface, the assembly comprising a chassis having a front and rear end, and one or more wheels supporting the chassis above the road surface intermediate said front and rear ends; a hopper mounted on the chassis having an inlet at an upper portion thereof for receiving the materials in the hopper, and an outlet at a lower portion of the hopper; and a metering wheel extending beneath the outlet for receiving the material therefrom, a speed of rotation of the metering wheel controllably delivering a volume of the materials to the road surface; wherein the assembly further comprises a stirrer located within the hopper and above the outlet and being configured to agitate the material within the hopper.

### CROSS-REFERENCE TO RELATED APPLICATION

This application claims priority to and the benefit of Australian Patent Application No. 2022903487, filed on Nov. 18, 2022, the entire disclosure of which is incorporated by reference herein.

### TECHNICAL FIELD

This disclosure relates generally to towed or mounted spreaders, and in particular to a spreader for use in road surfacing applications.

### BACKGROUND

Towed or mounted spreaders are used to provide a balanced distribution of materials across a surface. For example, spreaders are used in agricultural settings to distribute seeds, fertiliser, soil, manure or nutrients in an efficient manner. In a further example, spreaders are used for road maintenance to disperse the aggregate across a road surface. The aggregate typically comprises a granular material of mineral composition such as sand, gravel, shell, slag, limestone or crushed stone along with a cementing medium.

The spread rate of the materials distributed by the spreader is often controlled by the size and position of an outlet arranged at a lower end of a hopper that is configured to contain the materials for transport, and the speed with which the spreader is moved across the distribution surface. The materials are able to drop from the spreader through the outlet under the force of gravity. In some forms, spreaders may utilise a metering roller that is integrated with the outlet of the hopper in order to provide an even greater level of control over the spread rate.

However, some spreaders exhibit inaccurate or inconsistent spread rates, with friction inside the hopper, in combination with a compression of the material at the narrower funnel-like lower portion of the hopper adjacent the outlet, resulting in funnel flow from the outlet of the hopper which causes the spread rate to change over time during use. Whilst some spreaders incorporate a rattler or other means of vibrating the materials within the hopper in an attempt to at least partially remediate the effects of the material stagnating at the sides of the hopper due to the funnel flow effect, the flow rate of the materials from the hopper remains inconsistent, and the structural integrity of the spreader assembly can be compromised over time due to the vibrations.

There may be a need for a spreader assembly that is able to deliver an efficient and consistent spread rate when distributing materials across a surface.

### SUMMARY OF THE DISCLOSURE

In a first aspect, embodiments are disclosed of a mobile assembly for delivering materials to a road surface. The assembly comprises a chassis, a hopper, a metering wheel and a stirrer. The chassis has a front and rear end, and one or more wheels that support the chassis above the road surface intermediate the front and rear ends. The hopper is mounted on the chassis and has an inlet at an upper portion thereof for receiving the materials in the hopper, and an outlet at a lower portion of the hopper. The metering wheel extends beneath the outlet for receiving the material therefrom. The speed of rotation of the metering wheel controllably delivers a volume of the materials to the road surface. The assembly further comprises a stirrer that is located within the hopper and above the outlet. The stirrer is configured to agitate the material within the hopper.

The stirrer may advantageously agitate a mass flow of the materials through the outlet where substantially all of the materials move at an equivalent speed through the hopper outlet. This may result in a flow rate that is substantially consistent at both the side edges and at in the open centre of the outlet. By improving the consistency of the fluid flow rate of materials exiting the hopper through the outlet, the metering wheel may thus be more reliably filled to a constant volume and the spread rate of materials delivered to the road surface may be more consistent.

In some embodiments, the stirrer may comprise a paddle having a blade that extends radially away from a shaft of the stirrer to a free distal end and is arranged to rotate about the shaft so as to agitate the material within the hopper. In some embodiments, the paddle may comprises a plurality of the blades equidistantly spaced around a centrally located ring. In some embodiments, a plane of the blade of the paddle may be arranged on an angle relative to a longitudinal axis through the shaft. In some embodiments, the angle may be 45 degrees.

In some embodiments, the stirrer may comprise a plurality of the paddles intermediate opposing ends of the stirrer. In some embodiments, the plurality of paddles may be spaced at even intervals along the shaft of the stirrer.

In some embodiments, the metering wheel may comprise a plurality of segments, an adjacent two of the segments being separated by a wall that extends radially away from a shaft of the metering wheel to a free distal end and longitudinally along the shaft intermediate opposing ends of the shaft. In some embodiments, the metering wheel may comprise a pair of end plates, the end plates each being located at an opposing end of the wall/s. In some embodiments, each of the plurality of segments may have a substantially equivalent volume therein. In some embodiments, a flow rate of the materials between the stirrer and the metering wheel may be substantially constant.

In some embodiments, a cross-sectional area of the hopper proximal the upper portion thereof may be larger than a cross-sectional area of the hopper proximal the lower portion thereof whereby the materials are funneled towards the outlet. In some embodiments, one or more side wall of the hopper may define a sloped surface. In some embodiments, the hopper may be arranged as an inverted frustum rectangular pyramid. In some embodiments, the outlet may be an elongate rectangular opening arranged transversely across a base of the hopper.

In some embodiments, the shaft of the stirrer and/or metering wheel may extend transversely across the chassis. In some embodiments, the shaft of the stirrer, the shaft of the metering wheel and the outlet may extend parallel to one another. In some embodiments, the shaft of the stirrer, the shaft of the metering wheel and the outlet may be aligned along a vertical plane that extends transversely across the chassis. In some embodiments, the vertical plane may be aligned substantially centrally within the hopper.

In some embodiments, a speed of rotation of the metering wheel and the stirrer may be substantially equivalent.

In some embodiments, the metering wheel and the stirrer may be coupled to one another via a drive chain. In some embodiments, a motor may be configured to drive the rotation of the metering wheel and the stirrer. In some embodiments, the motor may be adjustably controllable to adjust the speed of rotation of the metering wheel and the stirrer. In some embodiments, the motor may be a hydraulic motor.

In some embodiments, the materials may comprise cementitious material. In some embodiments, the cementitious material may be lime based. In some embodiments, the cementitious material may comprise an additive including one or more of hydrated lime, cement, slag lime, slag cement, fly ash or cement blends.

Other aspects, features, and advantages will become apparent from the following detailed description when taken in conjunction with the accompanying drawings, which are a part of this disclosure and which illustrate, by way of example, principles of inventions disclosed.

### DESCRIPTION OF THE FIGURES

The accompanying drawings facilitate an understanding of the various embodiments. The invention will now be described, by way of non-limiting example only, with reference to the accompanying drawings, in which:

FIG. 1 is a front view of a first embodiment of the disclosed assembly.

FIG. 2A is a side section view through A-A of FIG. 1.

FIG. 2B is a close-up view of section B-B of FIG. 2A.

FIG. 3 is a rear section view through C-C of FIG. 2A.

FIGS. 4A, 4B, 4C and 4D are a perspective, top, rear and side view, respectively, of a first embodiment of a stirrer and metering wheel drive assembly.

FIGS. 5A and 5B are a perspective and front view, respectively, of a first embodiment of a stirrer.

FIGS. 6A and 6B are a perspective and side view, respectively, of a first embodiment of a paddle.

FIGS. 7A, 7B and 7C are a perspective, front and a section side view through D-D of FIG. 7B, respectively, of a first embodiment of a metering wheel.

FIG. 8 is a front view of a pivotable side panel of the metering chamber outlet.

### DETAILED DESCRIPTION

Referring to the Figures, a spreader assembly 100 is shown that is configured for use in road repair or stabilisation applications, and in particular to facilitate the distribution of a consistent volume of a material suitable for mixing into the surface layer below the assembly 100 as the assembly 100 is moved along the ground surface at a substantially constant speed. For example, the material spread may be a pozzolan/chemical additive used to stabilise the subgrade or pavement layer of a road such as hydrated lime, cement or other cementitious materials or mixes such as 70/30 Slag lime or slag cement etc. Where like reference numerals are used in the following description, the features are considered to be the same unless specified as being otherwise.

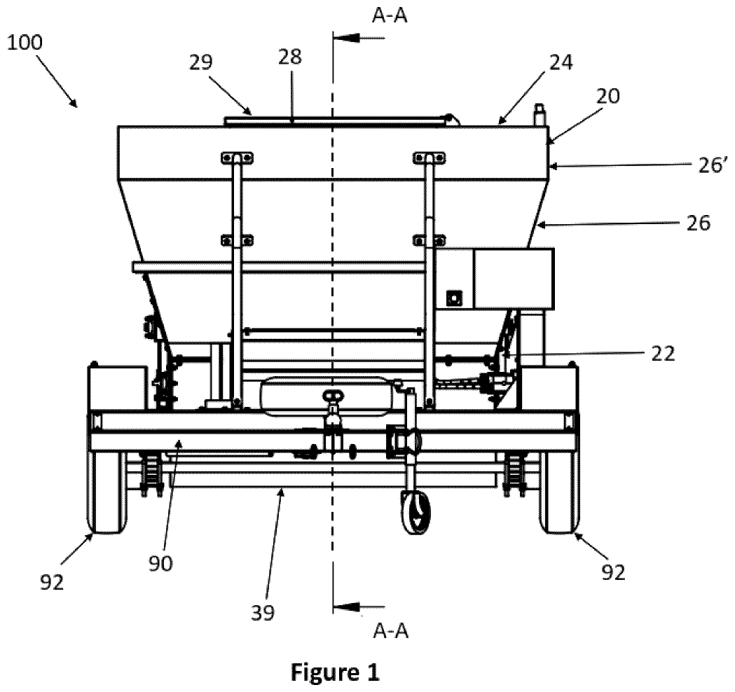

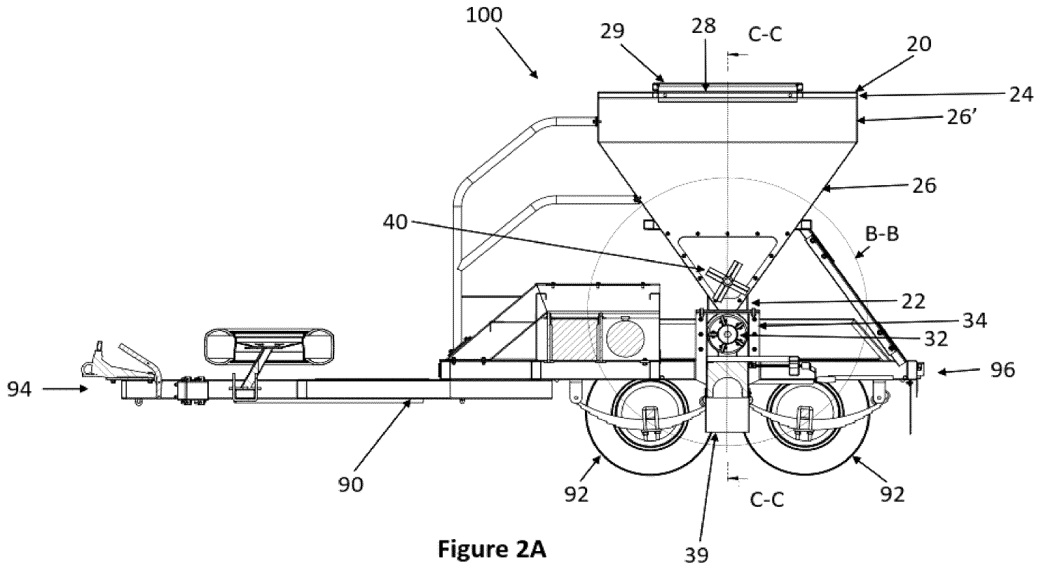

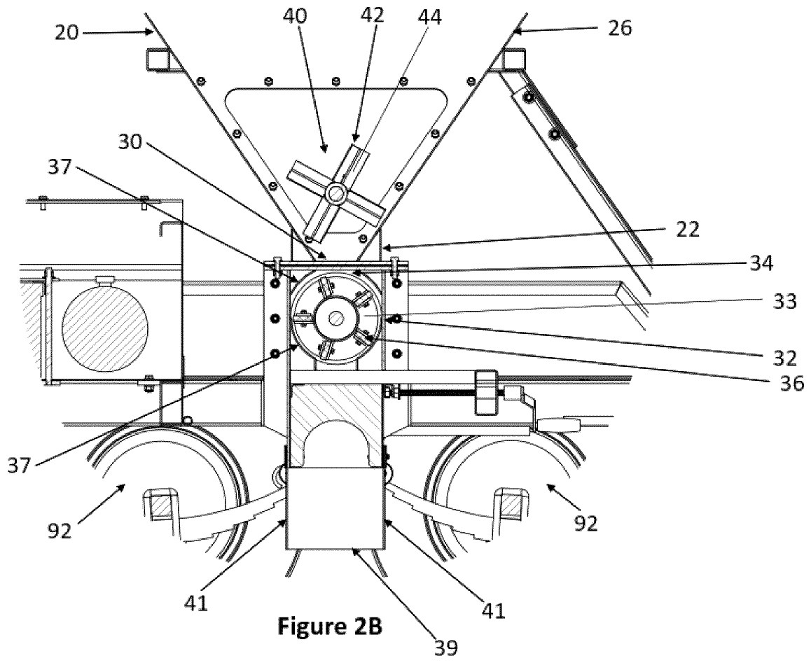

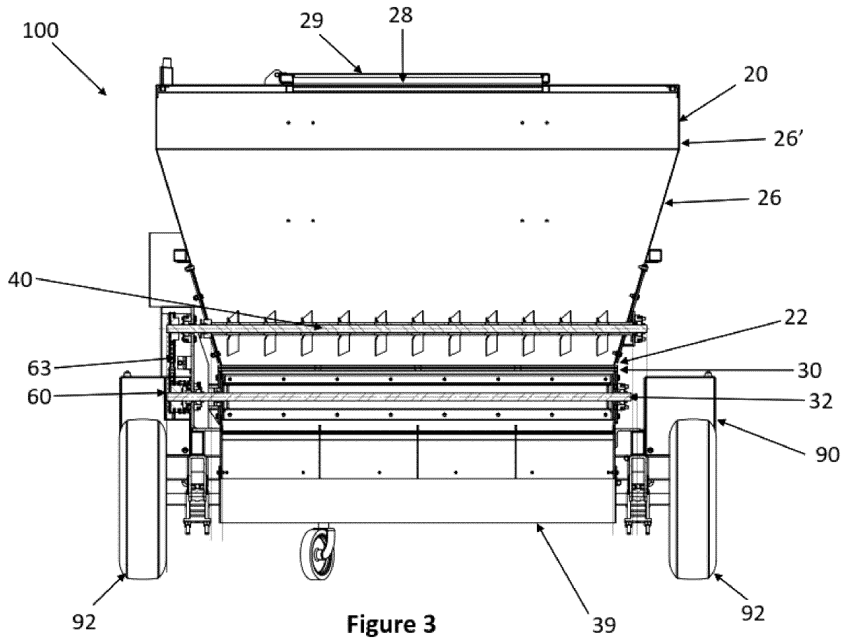

Referring now to FIGS. 1 to 3, the assembly 100 is mounted on a wheeled chassis 90 or trailer to facilitate mobility. The chassis 90 comprises four wheels 92, with two of the wheels 92 being arranged intermediate the front 94 and rear 96 ends of the chassis, on either side of the chassis 90, in order to support the chassis 90 above the road surface. The chassis 90 can be removably coupled to a vehicle at the front end 94 of the chassis 90 to enable towing of the assembly 100. A hopper 20 is mounted on the chassis 90, and is substantially centrally aligned between the wheels 92 of the chassis 90 such that the weight of the hopper 20 and materials is efficiently shared across each of the wheels 92. The hopper 20 defines an inverted trapezoidal shape, with the side walls 26 of the hopper sloping inwardly and downwardly towards the base 22 of the hopper 20 in the manner of an inverted frustum rectangular pyramid, such that the cross-sectional area of the hopper proximal to the upper surface 24 of the hopper 20 is larger than the cross-sectional area of the hopper 20 proximal the base 22 of the hopper 20. For example, the hopper 20 can be sized to store at least 1000 kg of stabilising material, having an internal volume of between 1.8 and 2 cubic metres. As would be appreciated by one skilled in the art, the hopper 20 acts as a funnel through which the materials being dispersed are allowed to flow under the force of gravity. It would be further appreciated by one skilled in the art that the hopper may take a variety of cross-sectional shapes such as square, circular, triangular and trapezoidal, and in addition one or more of the side walls may be vertically aligned for at least a portion of the height of the side wall, rather than sloped. For example, referring to FIG. 2A, the upper portion of each side wall 26′ of the hopper 20 is vertically aligned, whereas the lower portion of each side wall 26 of the hopper 20 is aligned to slope inwardly towards the base 22.

An inlet 28 is provided through the upper surface 24 of the hopper 20. The inlet 28 may span across part, or all, of the upper surface 24 and is arranged to facilitate receipt of a volume of materials into the hopper 20. The inlet 28 can be covered by a hinged hatch door 29, or similar removable cover, which may assist in reducing the risk of contaminants from entering the hopper 20. In a variation, not shown, the inlet can be formed through a side wall of the hopper proximal the upper surface of the hopper.

An outlet 30 is provided through the base surface 22 of the hopper 20. The outlet 30 defines an elongate rectangular opening that is arranged to extend transversely across the base surface 22 of the hopper 20. The outlet 30 is substantially centrally positioned along the base surface 22, with the width between opposing side walls 26 becoming increasingly narrow on all sides of the hopper 20 as they descend from the inlet 28 to the outlet 30, whereby materials stored in the hopper 20 are funneled towards and through the opening of the outlet 30. The lower portion of the hopper 20 proximal the outlet 30 thus defines a funnel area of the hopper 20. In a variation, not shown, the outlet can be formed through a side wall of the hopper proximal the base surface of the hopper.

The hopper 20 defines a relatively short silo with relatively high friction forces between the internal surfaces of the side walls 26 in comparison to the relatively low pressure resulting from the short material head. The height of the side walls 26 of the hopper 20 are relatively short in comparison with the cross-sectional width of the hopper 20. The slope of the side walls 26 of the hopper 20 is therefore relatively gentle, and not steep enough to naturally enable mass flow, instead providing a flow channel through the centre of the outlet 30, with a portion of the material remaining somewhat stagnant at the periphery of the outlet adjacent the side walls 26 due to the friction of the side walls 26 (i.e. funnel flow).

The material that flows from the hopper 20 through the outlet 30 is allowed to fall under the force of gravity into a metering chamber 34 located beneath the outlet 30. The elongate metering chamber 34 extends transversely across the hopper 20 in alignment with, and beneath, the opening of the outlet 30, and has curved side walls 37 that correspond to, and wrap around, the outer diameter of an elongate metering wheel 32 that is configured to rotate about its shaft 35 within the metering chamber 34. The metering wheel 32 extends across the width of the metering chamber 34 beneath the outlet 30 such that passage through the metering chamber 34 is obstructed by the metering wheel 32, and the materials entering the metering chamber 34 from the outlet 30 are not able to freely bypass the metering wheel 32 to the metering chamber outlet 39.

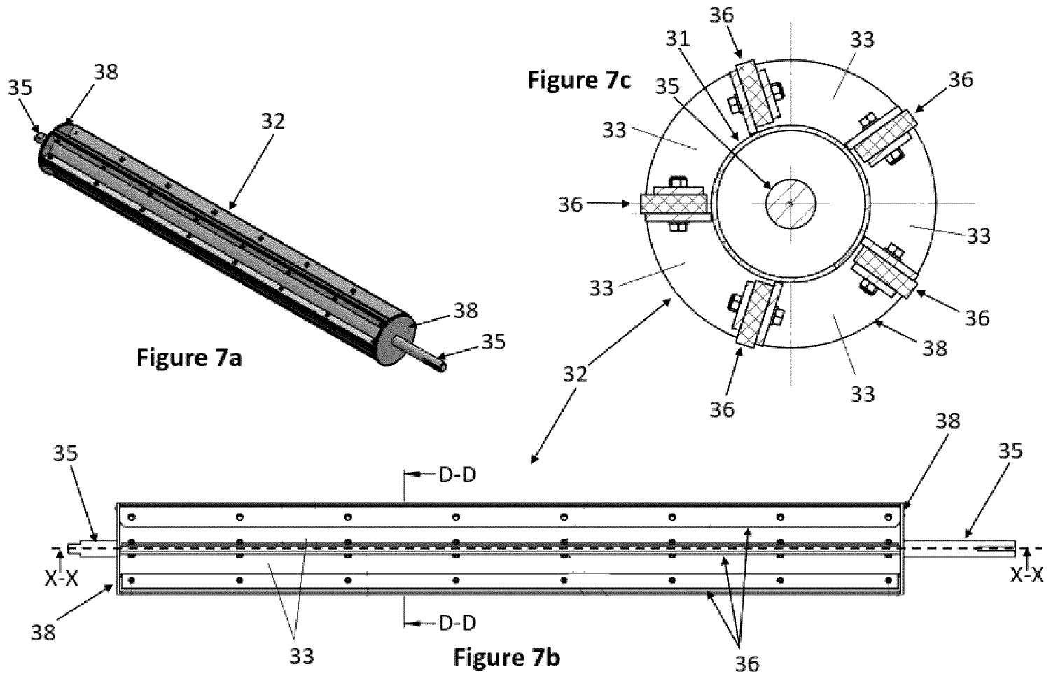

Referring to FIGS. 7A to 7C, the metering wheel 32 is divided into at least two segments 33, with each of the plurality of segments 33 defining a bucket-like receptacle sized to receive up to a maximum volume of materials falling from the outlet 30 into the metering chamber 34. For example, a segment 33 can have a volume between 4 and 6 Litres, and in some embodiments 5.03 Litres. Each of the segments 33 contains a substantially equivalent maximum volume. As the shaft 35 of the metering wheel 32 rotates about its longitudinal axis X-X, the adjacent segment 33′ rotates into a position where it is exposed to be open in a generally upwards direction opposite the opening of the outlet 30. An adjacent two of the segments 33 of the metering wheel 32 are separated by a wall 36 that extends radially away from a shaft 35 of the metering wheel 32 to a free distal end. The wall 36 also extends longitudinally along the shaft 35 intermediate the opposing ends of the shaft 35 between a pair of end plates 38. The diameter of the base surface 31 of the segments 33 can in some forms be larger than the diameter of the shaft 35 about which the metering wheel 32 rotates. As would be appreciated by a person skilled in the art, the number of segments, radial spacing of the walls around the shaft, diameter of the base surface of the segments, height of the walls above the base surface of the segments can be varied to define the maximum volume of material that can be received and contained within a single segment.

In use, a first segment 33 that locates adjacent to, and opposite, the opening of the outlet 30 is arranged to be open, and face in a generally upwards direction, such that the materials falling from the outlet 30 of the hopper 20 are received within the segment 33 until the segment 33 is filled to its maximum volume. As the metering wheel 32 rotates about the shaft 35, each elongate segment 33 of the metering wheel 32 is sequentially, in turn, positioned and aligned below the elongate opening of the outlet 30 to allow the materials falling through the outlet 30 to be received, and effectively captured by, the respective adjacent segment 33 of the metering wheel 32. Excess materials that accumulate above the height of the segment walls 36 are able to be brushed off into the adjacent following segment 33′ by the side walls 37 of the metering chamber 34. In this manner, the maximum volume of materials able to be contained within a single segment 33 is constrained. The constant volume of the materials in each segment 33 of the metering wheel 32 is rotated about the shaft 35 until at least a portion of the segment 33 locates adjacent to, and opposite, the opening of the metering chamber outlet 39, in a configuration where the segment 33 is arranged to be open, and face in a generally downwards direction, such that the materials are able to fall out of the segment 33 under the force of gravity. Materials deposited by the metering wheel 32 are allowed to fall through the metering chamber outlet 39 to the road surface below the assembly 100. The metering chamber outlet 39 can be centrally aligned beneath the hopper 20 and between the wheels 92 of the chassis 90. The speed of the rotation of the metering wheel 32 is thus able to control the rate of delivery of the materials to the road surface (i.e. the spread rate of the materials from the assembly 100). If the last segment 33 is not filled with materials, the assembly 100 stops distributing the materials and the hopper 20 can be refilled via the inlet 28. The assembly 100 can then restart distributing the materials from the location at which the previous load of materials were exhausted.

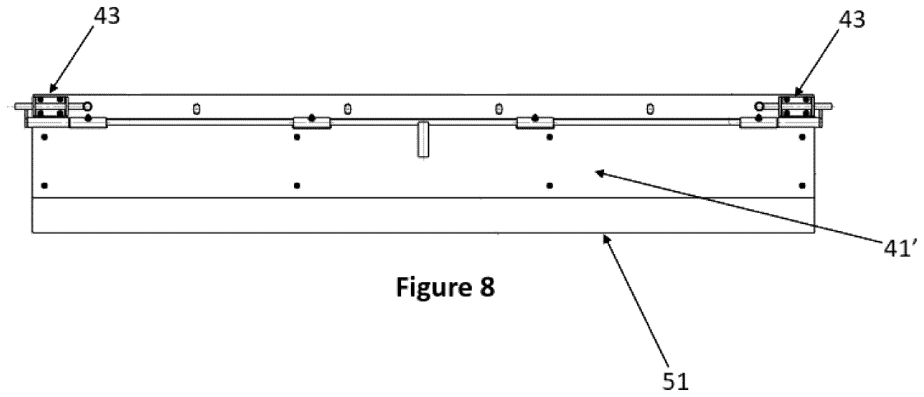

In some variations, a side panel 41′ of the metering chamber outlet 39 can be arranged to pivot across towards the fixed side panel 41 on the opposing side of the outlet 39, and thereby close the outlet 39 beneath the metering wheel 32. The side panel 41′ can thus act as a shutoff gate that may advantageously prevent residual material from falling out of the metering wheel 32 onto the road surface when it is not desired that material be deposited from the assembly 100. For example, with reference to FIG. 8, the elongate side panel 41′ can be coupled to the lower portion of the metering chamber 34 by one or more hinges 43 that facilitate the inward rotation of the side panel 41′ across the metering chamber outlet 39. A semi-flexible skirt flap 51 can extend along a length of the side panel 41′, and in-use is adapted to resiliently engage with the inner facing surface of the opposing fixed side wall 41 so as to substantially seal across the metering chamber outlet 39. The pivotable side panel 41′ can have a length that is substantially equivalent to that of the fixed side panel 41, and arranged to extend transversely across a base of the hopper 20.

A stirrer 40 is arranged to rotate within the hopper 20 to agitate the material within the hopper 20. The fluid consistency of the materials contained within the hopper 20, and in particular within the relatively small funnel area of the hopper 20 proximal the outlet 30, can vary greatly under the forces of gravity alone, with materials in contact with the internal surfaces of the side walls 26, and in particular the side walls 26 of the funnel area of the hopper 20, experiencing highly variable frictional forces. Without the stirrer 40, the materials would experience funnel flow through the hopper 20, with materials passing through the centre of the hopper 20 moving at a faster relative speed through the hopper 20 than the materials located adjacent the side walls 26 of the hopper 20, thereby causing the materials to exhibit varying exit speeds as they passed through the outlet 30. This would also cause a varying volume distribution across the cross-section of the outlet 30 with less materials exiting proximal the side walls 26 and edges of the opening of the outlet 30 relative to a larger volume of materials exiting through the centre of the outlet 30. The assembly 100 thus utilises the agitation of the stirrer 40 to remove, or at least reduce, the effects of friction by stimulating mass flow of the materials through the outlet 30, where substantially all of the materials move at an equivalent speed through the hopper 20, resulting in a flow rate that is substantially consistent at both the sides walls 26 and edges of the opening of the outlet 30 and at the centre of the opening of the outlet 30. By improving the consistency of the fluid flow rate of materials exiting through the outlet 30, the segment 33 of the metering wheel 32 can be more reliably filled to a constant volume (i.e. the maximum volume). Further, by ensuring that each segment 33 of the metering wheel 32 contains substantially the maximum volume, the assembly 100 is able to reliably deposit and spread a constant and accurate (within a range of approximately +/−10%) metered volume of material to the road surface. In addition, the residence time of materials in the hopper 20 may be reduced.

The elongate shaft 45 of the stirrer 40 extends transversely across the hopper 20 in alignment with, and above, the opening of the outlet 30. The stirrer shaft 45 is positioned in the lower region of the hopper 20 and centrally above the outlet 30, with the blades 44 of the paddles 42 of the stirrer 40 having at least a 5 mm clearance away from the inwardly sloping side walls 26 of the hopper 20. The shaft 45 of the stirrer 40 and the shaft 35 of the metering wheel 32 extend parallel to one another, and are each aligned along a substantially central vertical plane C-C that extends transversely across the hopper 20 and chassis 90, with the coplanar parallel shafts 35,45 of the metering wheel 32 and stirrer 40 being spaced from one another below and above the outlet 30, respectively. The outlet 30 can also be centrally aligned with the central vertical plane C-C and extend substantially parallel to the shafts 35,45 of the metering wheel 32 and stirrer 40.

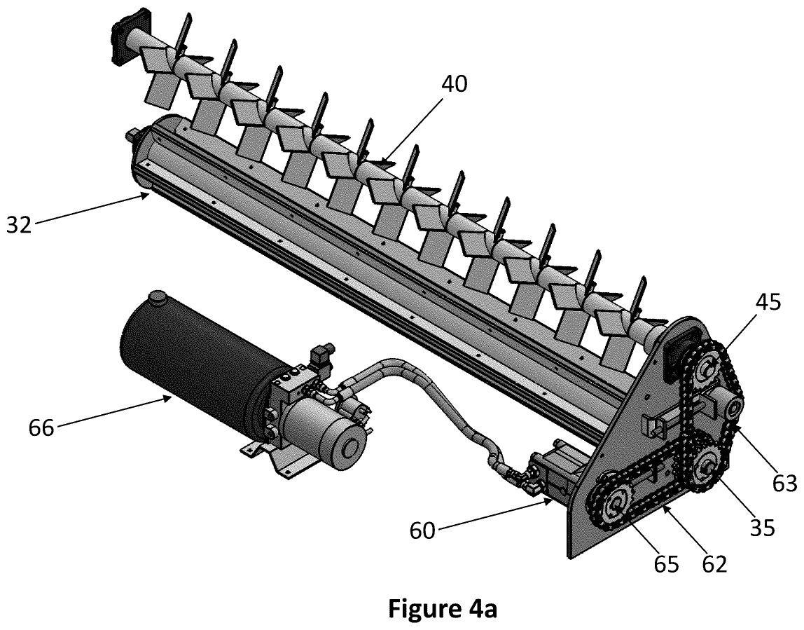

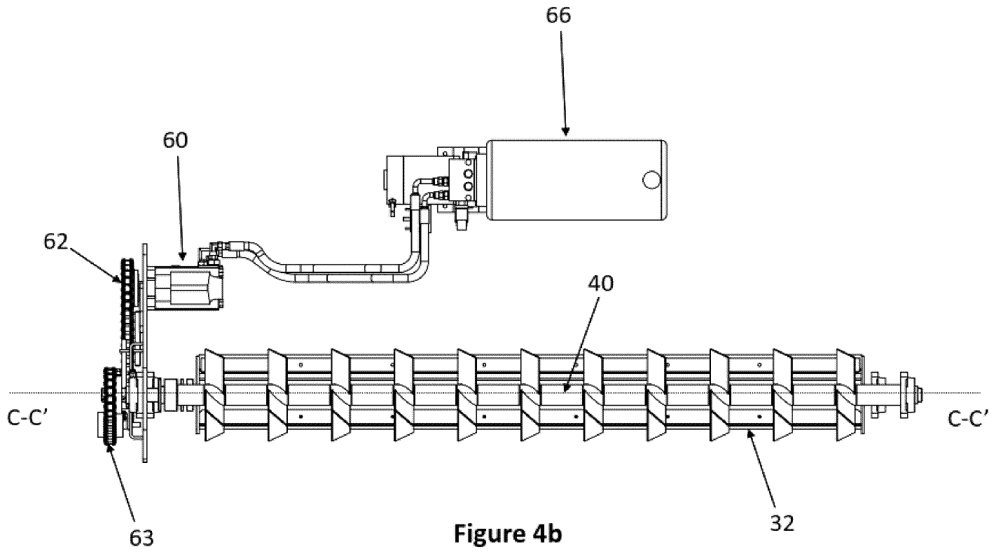

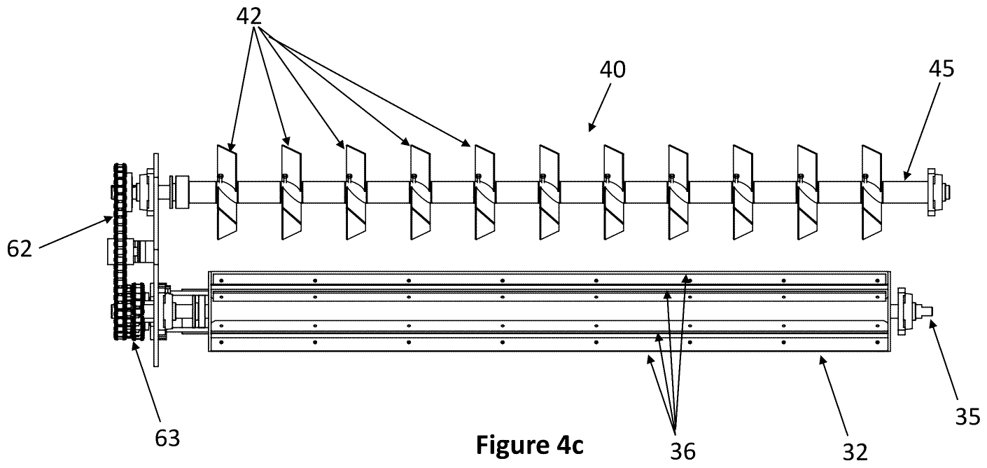

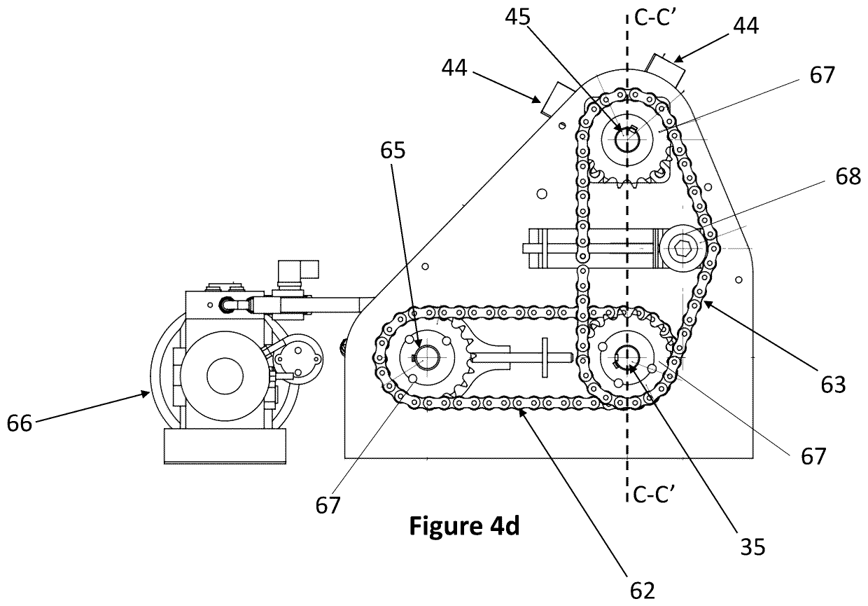

Referring to FIGS. 4A to 4D, the shaft 35 of the metering wheel 32 is coupled via a first drive chain 62 to a drive shaft 65. The drive shaft 65 is driven to rotate at a constant speed by a motor 60. The motor 60 can be, for example, a hydraulic motor with a hydraulic cylinder 66. The motor 60 spins at a constant pre-configured rate that can be adjusted in order to rotate the metering wheel 32 and stirrer 40 at a faster or slower speed of rotation. For example, the motor 60 can be pre-set to operate at 80 rpm. As would be appreciated by a person skilled in the art, the motor can be pre-set to operate at faster or slower speeds, with the spread rate of the materials from the assembly 100 being a function of the vehicle speed, the speed of rotation of the metering wheel 32 by the motor 60 and the material density and/or particle size within the hopper 20. If the speed of the motor 60 is too fast, the segments 33 of the metering wheel 32 are not able to consistently fill to the same maximum volume. By contrast, if the speed of the motor 60 is too slow, the resulting spread rate may be insufficient and may thus require multiple passes of the assembly 100 causing a patchy and inconsistent distribution of the materials. For example, in one variation, when the vehicle moves the assembly 100 at a constant speed of 4 km/hr, a constant spread rate, within a range of +/−10%, may be achieved and maintained of approximately 8 kg/m². The spread rate could be reduced by driving the assembly 100 to move at a faster speed, or by reducing the speed of rotation of the metering wheel 32 by the motor 60, or by increasing the fluid density of the material within the hopper 20.

The motor 60 is also adjustably controllable by a control system in order to start and stop operation of the motor. The motor 60 allows an operator to start or stop the distribution of material from the assembly 100 with high accuracy. This can be important in road repair or stabilisation applications in order to avoid accidentally spreading caustic materials on a ground surface other than at a location where the materials will be mixed into the surface being stabilised. The motor 60 can thus be controlled to start and stop distributing materials to the surface from the assembly 100 with high accuracy, for example when resuming distribution of the materials from the location at which distribution had previously been stopped. The control system can be configured to receive manual inputs, or to communicate wirelessly with a remote control device, for example, via Bluetooth or other wireless communication technologies. In a variation, the the speed of rotation of the drive shaft can be adjusted by the control system. In a further variation, not shown, the motor can be controlled by the control system to responsively adjust the speed of rotation of the motor in real time based on one or more detected parameters such as the fluid density within the hopper and/or the speed of travel of the vehicle.

The shaft 45 of the stirrer 40 is coupled to the shaft 35 of the metering wheel 32 via a second drive chain 63. The second drive chain 63 can be tensioned by a chain tensioner 68. The gears 67 secured at the end of the respective shafts 35,45,65 have a gear ratio of 1:1 whereby each of the stirrer and metering wheel shafts 45,35 rotate simultaneously through one revolution at the same speed. As would be appreciated by a person skilled in the art, the gear ratio can be varied to rotate the metering wheel shaft 35 or stirrer shaft 45 at a relative speed that differs to that of the other shaft.

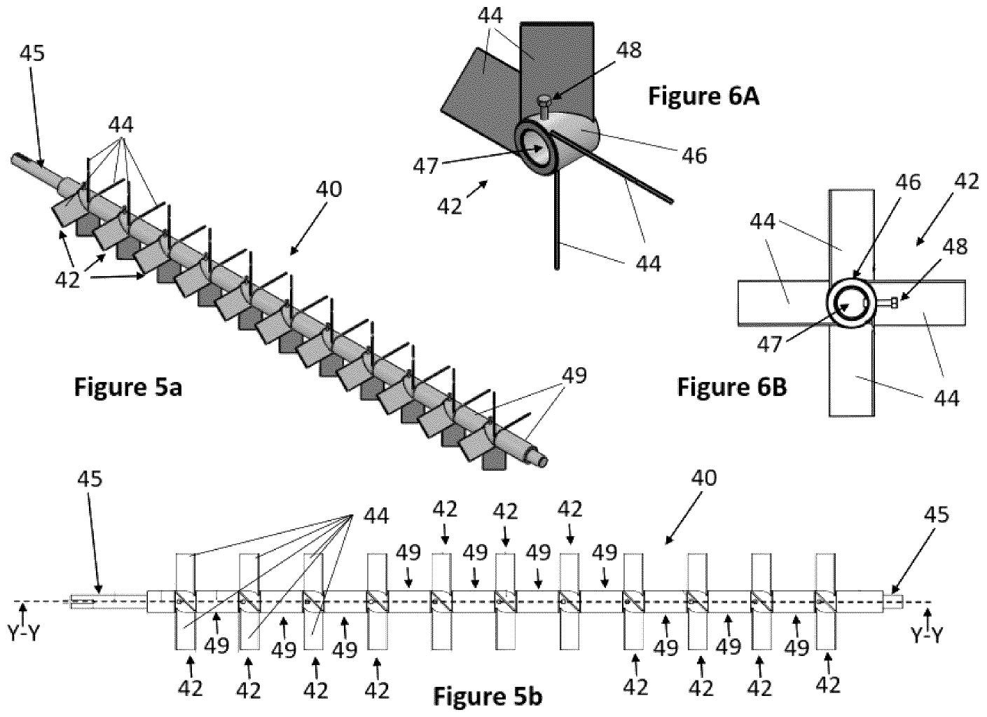

The stirrer 40 comprises at least one paddle 42 having at least one blade 44 arranged to rotate about the shaft 45 so as to agitate the material within the hopper 20. Referring to FIGS. 5 and 6, the stirrer 40 can comprise a plurality of individual paddles 42, each paddle comprising four blades 44 arranged to extend radially away from a central ring 46 to a respective distal end. For example, a distal end of a blade 44 of a paddle 42 can extend to a length of approximately 113 mm away from the central axis of the shaft 45, whilst the stirrer 40 can have a total diameter between 192 and 197 mm in length. The gap between the distal edges of the blades 44 of the stirrer 40 and the side walls 26 of the hopper 20 can be as small as 1 mm. The diameter of the stirrer 40 (from blade edge to blade edge) can be greater than the diameter of the metering wheel 32. In a variation, not shown, the diameter of the stirrer (from blade edge to blade edge) can be smaller than the diameter of the metering wheel. The planar surface of each blade 44 of a paddle 42 is arranged on a 45 degree angle relative to a longitudinal axis Y-Y through the shaft 45. As would be appreciated by a person skilled in the art, the size and angle of the blades can be varied in accordance with the specific dimensions of the embodiment of the assembly. A through hole 47 through the central ring 46 is sized to closely correspond to, and receive therethrough, the shaft 45 of the stirrer 40. The paddle 42 can be removably secured to the shaft 45 of the stirrer 40 by at least one fastener 48. In variations, not shown, the paddle can be fixedly secured to the shaft or integrally formed with the shaft. The blades 44 can each be spaced at equidistantly from one another around the circumference of the central ring 46. In a variation, not shown, the paddles can comprise between one and ten blades arranged in an equidistantly spaced manner around a central ring. Each paddle 42 can be spaced along the shaft 45 from an adjacent paddle 42 at equidistant intervals by at least one tubular spacer 49, with a plurality of paddles 42 and/or spacers 49 locating along the shaft 45 intermediate the opposing ends of the shaft 45. In a variation, not shown, the intervals between adjacent paddles can be non-equidistant. In a variation, not shown a spacer can be integrally formed to protrude from one or both sides of each paddle. As would be appreciated by a person skilled in the art, variations are contemplated where a plurality of paddles having a single or plurality of blades, each paddle being spaced apart by one or more spacers, can be integrally formed together as a single unit that is able to be mounted on the shaft, or that is integrally formed with the shaft itself.

In use, the stirrer 40 creates a consistent density and head pressure of materials in the hopper 20 above the outlet 30. This assists with maintaining the fluidity of the materials, reducing the effects of side wall 26 friction on the materials, or instances of the materials clumping, both of which may result in a funnel flow of the materials through the outlet 30 (i.e. non-constant flow rate across the outlet 30 into the metering wheel 32, and which in turn may lead to uneven distribution of the materials on the road surface). Instead, the stirrer 40 promotes mass fluid flow of the materials through the outlet 30, with the materials falling from the hopper 20 through the outlet 30 at a reliable substantially constant and consistent flow rate of the materials across the opening of the outlet 30. The mass flow of the materials through the outlet may thus advantageously facilitate an improved accuracy and consistency of the spread rate, within a range of +/−10%.

Where like reference numerals are used in the following description, the features are considered to be the same unless specified as being otherwise.

Variations and modifications may be made to the parts previously described without departing from the spirit or ambit of the disclosure.

In the foregoing description of preferred embodiments, specific terminology has been resorted to for the sake of clarity. However, the invention is not intended to be limited to the specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A mobile assembly for delivering materials to a road surface, the assembly comprising:
a chassis having a front and rear end, and one or more wheels supporting the chassis above the road surface intermediate said front and rear ends;
a hopper mounted on the chassis having an inlet at an upper portion thereof for receiving the materials in the hopper, and an outlet at a lower portion of the hopper; and
a metering wheel extending beneath the outlet for receiving the material therefrom, a speed of rotation of the metering wheel controllably delivering a volume of the materials to the road surface;
wherein the assembly further comprises a stirrer located within the hopper and above the outlet and being configured to agitate the material within the hopper.

2. The assembly as claimed in claim 1, wherein the stirrer comprises a paddle having a blade that extends radially away from a shaft of the stirrer to a free distal end and is arranged to rotate about the shaft so as to agitate the material within the hopper.

3. The assembly as claimed in claim 2, wherein the paddle comprises a plurality of the blades equidistantly spaced around a centrally located ring.

4. The assembly as claimed in claim 2, wherein a plane of the blade of the paddle is arranged on an angle relative to a longitudinal axis through the shaft.

5. The assembly as claimed in claim 4, wherein the angle is 45 degrees.

6. The assembly as claimed in claim 2, wherein the stirrer comprises a plurality of the paddles intermediate opposing ends of the stirrer.

7. The assembly as claimed in claim 6, wherein the plurality of paddles are spaced at even intervals along the shaft of the stirrer.

8. The assembly as claimed in claim 1, wherein the metering wheel comprises a plurality of segments, an adjacent two of the segments being separated by a wall that extends radially away from a shaft of the metering wheel to a free distal end and longitudinally along the shaft intermediate opposing ends of the shaft.

9. The assembly as claimed in claim 8, wherein the metering wheel comprises a pair of end plates, the end plates each being located at an opposing end of the wall/s.

10. The assembly as claimed in claim 8, wherein each of the plurality of segments has a substantially equivalent volume therein.

11. The assembly as claimed in claim 1, wherein a flow rate of the materials between the stirrer and the metering wheel is substantially constant.

12. The assembly as claimed in claim 1, wherein a cross-sectional area of the hopper proximal the upper portion thereof is larger than a cross-sectional area of the hopper proximal the lower portion thereof whereby the materials are funneled towards the outlet.

13. The assembly as claimed in claim 1, wherein one or more side wall of the hopper defines a sloped surface.

14. The assembly as claimed in claim 1, wherein the hopper is arranged as an inverted frustum rectangular pyramid.

15. The assembly as claimed in claim 1, wherein the outlet is an elongate rectangular opening arranged transversely across a base of the hopper.

16. The assembly as claimed in claim 1, wherein the shaft of the stirrer and/or metering wheel extend/s transversely across the chassis.

17. The assembly as claimed in claim 1, wherein a shaft of the stirrer, a shaft of the metering wheel and the outlet extend parallel to one another.

18. The assembly as claimed in claim 17, wherein the shaft of the stirrer, the shaft of the metering wheel and the outlet are aligned along a vertical plane that extends transversely across the chassis.

19. The assembly as claimed in claim 18, wherein the vertical plane is aligned substantially centrally within the hopper.

20. The assembly as claimed in claim 1, wherein a speed of rotation of the metering wheel and the stirrer is substantially equivalent.

21. The assembly as claimed in claim 20, wherein the metering wheel and the stirrer are coupled to one another via a drive chain.

22. The assembly as claimed in claim 20, wherein a motor is configured to drive the rotation of the metering wheel and the stirrer.

23. The assembly as claimed in claim 22, wherein the motor is adjustably controllable to adjust the speed of rotation of the metering wheel and the stirrer.

24. The assembly as claimed in claim 22, wherein the motor is a hydraulic motor.

25. The assembly as claimed in claim 1, wherein the materials comprise cementitious material.

26. The assembly as claimed in claim 25, wherein the cementitious material is lime based.

27. The assembly as claimed in claim 25, wherein the cementitious material comprises an additive including one or more of hydrated lime, cement, slag lime, slag cement, fly ash or cement blends.

28. The assembly as claimed in claim 1, wherein the stirrer agitates a mass flow of the materials through the outlet.
